(19) United States
(12) Patent Application Publication
(10) Pub. No.: US 2002/0139226 A1
(43) Pub. Date: Oct. 3, 2002

(54) Articulated wrench

(76) Inventor: Ronald A. Hansen, Tyler, TX (US)

Correspondence Address: SEFRNA & ASSOCIATES, P.O. Box 567, Tyler, TX, 75710-0567, US

(21) Appl. No.: 09/824,405

(22) Filed: Apr. 2, 2001

(51) Int. Cl. B25B 23/16

(52) U.S. Cl. 81/177.8

(57) ABSTRACT

An articulated wrench includes an elongate handle with a generally U-shaped depression at an end of the handle with an edge portion of the handle extending on either side of the depression, and a wrench head formed as a generally planar body with an aperture therein for engaging a component to be turned with the wrench, with the body of the wrench head nested into the depression in the handle with the edge portions of the handle on either side of the depression extending along a portion of the edge of the wrench head, and with the wrench head pivotally interconnected to the handle so as to allow rotation of the wrench head relative to the handle.

### FIELD OF THE INVENTION

The present invention generally relates to hand tools, and in its preferred embodiments more specifically relates to a wrench with an articulating head pivotally connected to the handle of the wrench.

### BACKGROUND OF THE INVENTION

It is not unusual for bolt heads, nuts, screws and the like used in the construction of various machines and structures to be placed in locations in which they are difficult to engage and turn with a conventional wrench. This situation is encountered frequently in the automotive field, though it is certainly not limited to that field, and it is not unusual for a mechanic to find it necessary to remove parts in order to provide sufficient clearance to engage a bolt head, not, or other component and turn the component to release and remove it. The same problem is usually encountered when the bolt, etc. is to be replaced and tightened. The problem of insufficient access is particularly frustrating when the component to be engaged and turned can be engaged with a wrench head but the wrench cannot be turned because of insufficient clearance. In some situations a socket wrench with an extension between the handle and the socket can be effectively used, if the bolt head or the like is not obstructed from the top and if length of the extension is sufficient to place the handle beyond a structure adjacent to the bolt head, etc. However, in many situations these requirements are not met and a socket wrench cannot be used.

One approach that has been tried in an effort to overcome this problem is the use of wrenches with pivoting heads, in which the component engaging head is pivotally connected to the wrench handle so the plane of the head can be disposed at an angle to the handle. Wrenches with pivoting heads are known in the prior art, as exemplified by U.S. Pat. No. 4,084,456 to Pasbrig. Such known prior art designs do serve to facilitate engaging the wrench head with a component to be turned in many situations. However, the prior art designs continue to suffer from disadvantages and drawbacks, and have proven to be ineffective in many situations.

In the known articulating wrenches of the prior art the pivot point is placed at a relatively significant distance from the component-engaging portion of the wrench head, as is the case with the Pasbrig wrench, making the wrench ineffective when there is insufficient clearance between the component to be turned and an adjacent object to receive the wrench head. It is a relatively common circumstance for a bolt head or nut to be positioned next to an obstruction that extends parallel to the bolt axis, and to be below an obstruction that extends radially over the bolt head or nut so as to prevent access by a socket wrench. In such situations the articulated wrench designs of the prior art may prove to be no more useful for engaging and turning the bolt or nut than are conventional, non-articulated designs. There remains a need for an articulating wrench that can be effectively used when only minimal clearance is available between the component to be engaged and turned and adjacent structures.

### SUMMARY OF THE INVENTION

The present invention provides an articulating wrench of the box end or open end type, having at least one head pivotally interconnected to the handle of the wrench. The wrench of the invention is particularly useful for effectively engaging nuts, bolt heads, and the like that are disposed in locations that provide limited access for engaging and turning such components.

In the wrench of the invention the distance from the outer end of the wrench head to the point at which it is pivotally connected to the handle is minimized, so that the wrench can be inserted into more severely constricted areas to engage and turn a component than has been previously possible. Articulated wrenches of the prior art may be generally characterized as having a wrench head with a pivot arm extending outwardly from the head and into a slot formed in the handle. A pivot pin is used to pin the wrench head extension within the slot. The distance from the center of the wrench head to the outer end of the pivot arm defines the minimum clearance from the center of a bolt head or the like to an obstruction that must be present to allow use of the wrench.

In the wrench of the invention, the pivot arm is eliminated and the wrench head is nested directly into the end of the wrench handle. The end of the handle is formed with a U-shaped depression, the edges of which are flared outwardly to match the curvature of the wrench head. The wrench head is formed with cutouts matching the configuration of the flared edges of the depression in the handle, so that when the wrench head is nested in the depression the handle partially overlaps the wrench head. A pivot pin extending through the flared edges of the handle depression and the nested portion of the wrench head enables the head to pivot relative to the handle. In the preferred embodiment the angle through which the head is allowed to pivot is not restricted, but in an alternative embodiment of the invention the angle through which the head is allowed to pivot relative to the handle is constrained by the use of a stop pin and groove arrangement. A wrench made in accordance with the invention may include an articulated box end head, open end head, or both. A wrench made in accordance with the invention may provide an articulated head at only one end of the handle or at both ends of the handle. If two articulated heads are used they may be of the same type or of different types, all within the scope of the invention.

The structure and features of the invention will be described in more detail with reference to the accompanying drawing figures.

### BRIEF DESCRIPTION OF THE DRAWINGS

FIG. 1 is a top view of a preferred embodiment of the wrench of the invention, viewed perpendicular to the plane of the heads and handle.

FIG. 2 is a side view of the embodiment of FIG. 1, with the articulating head rotated ninety degrees, viewed parallel to the plane of the head and handle.

FIG. 3 is a side view of the articulating head of the embodiment of FIG. 1.

FIG. 4 is an end view of an alternative embodiment of the articulating head of the wrench, showing a groove used to limit rotation of the head.

FIG. 5 is an end view of an alternative embodiment of the handle of the wrench, showing a stop pin to function cooperatively with the groove shown in FIG. 4.

FIG. 6 is a top view of an embodiment of the invention with an articulated open end wrench head.

FIG. 7 is a top view of an embodiment of the invention with an articulated box end wrench head at both ends of the handle.

FIG. 8 is a top view of an embodiment of the invention with an articulated open end wrench head at both ends of the handle.

FIG. 9 is a top view of an embodiment of the invention with an articulated open end wrench head at one end of the handle and with an articulated box end wrench head at the opposite end of the handle.

### DETAILED DESCRIPTION OF THE INVENTION

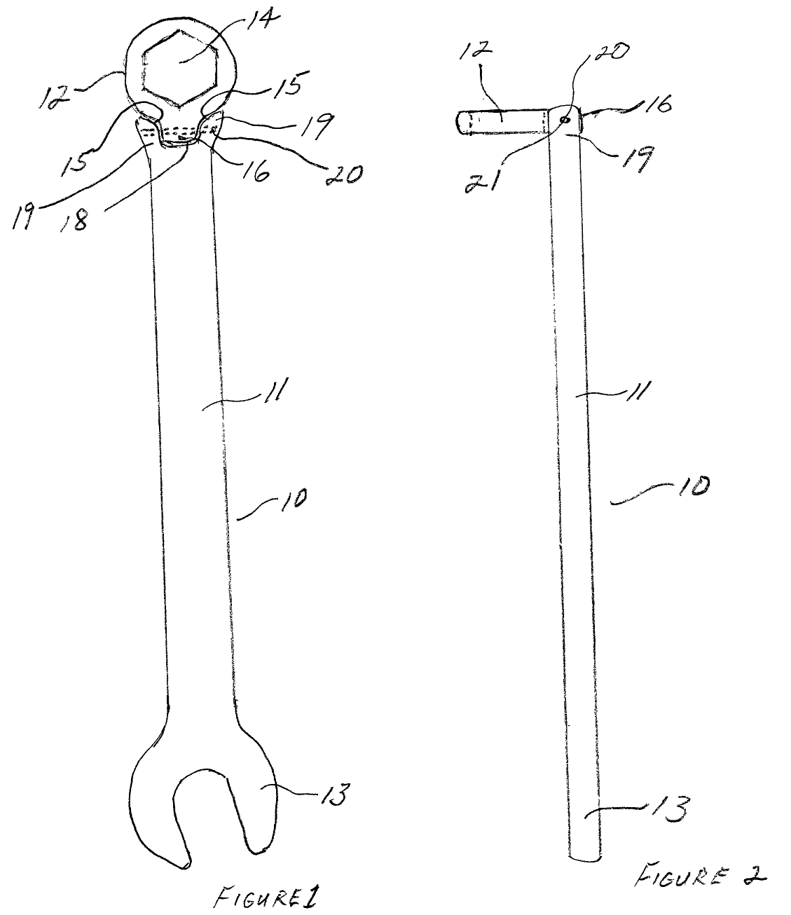

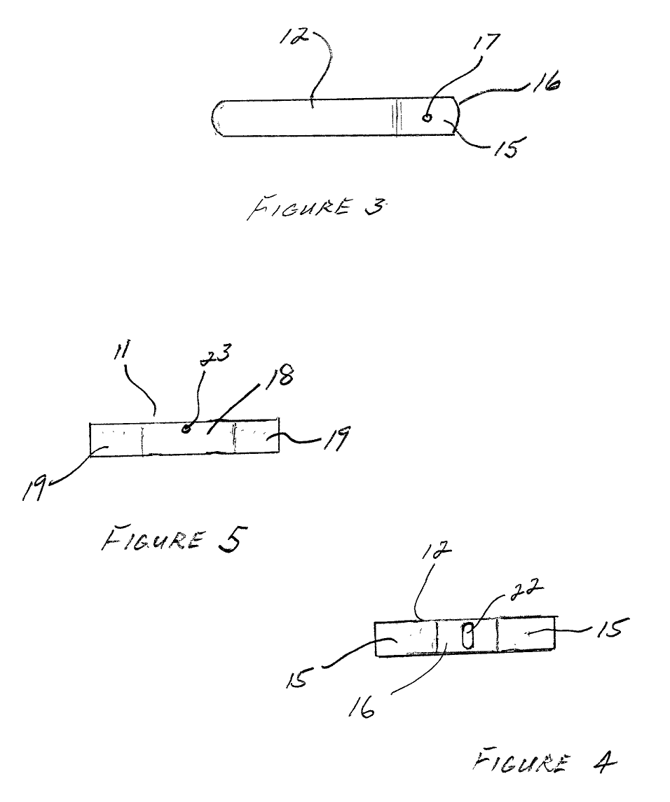

Referring to the drawing figures, the wrench of the invention, generally designated by reference numeral 10, will be seen to comprise an elongate handle 11, a first head 12 disposed at one end of the handle, and a second head 13 disposed at the opposite end of the handle. In the embodiment illustrated in FIGS. 1 and 2 the wrench is configured as a combination wrench, with head 12 being of the box end type and articulated, and with head 13 being of the open end type and fixed, but any configuration may be used within the scope of the invention. It is preferred that at least one articulated head be of the box end type so as to allow minimization of the dimensions of the head, but an articulated open end type head may be used within the scope of the invention.

In the illustrated embodiment head 12 is a generally planar body preferably of circular configuration, although a slightly ovoid configuration may be used, and is penetrated by a typically hexagonal aperture 14 adapted to be received over a bolt head or nut to be engaged by the wrench. A pair of cut-outs 15 are formed in the annular portion of the head, or ring, surrounding the central aperture, with the cut-outs disposed in mirrored relation on either side of a diameter line of the circular head and offset from a perpendicular diameter line. If an ovoid head is used the cut-outs are positioned on either side of the major axis of the ovoid near the end with the smaller radius. The smaller portion of the annular ring remaining between the cut-outs forms extension 16. Extension 16 is penetrated by a pivot pin aperture 17 with its axis parallel to the plane of the head and equidistant between the two faces of the head.

The portion of wrench handle 11 near its first end is generally planar, of a thickness generally equal to the thickness of head 12. The first end of handle 11 is formed with a generally U-shaped depression 18 extending into the handle from the first end. In the preferred embodiment depression 18 is wider at its outer end, associated with the first end of the handle, than at its inner end. The edge portions of the handle on either side of the depression, designated by numeral 19, are preferably flared outwardly at the first end of the handle. The configuration of the first end of the handle is matched to the configuration of the head so that extension 16 is received within depression 18 and the flared edges 19 of the handle are received in cut-outs 15, so as to nest head 12 in the first end of handle 11. The flared edges are penetrated by coaxially aligned pivot pin apertures 20, which are coaxially aligned with pivot pin aperture 17 when the head 12 is in place for connection to handle 11. A pivot pin 21 extends through aligned apertures 17 and 20 to form the pivotal connection of head 12 to handle 11. It is preferred that the pivot pin fit relatively tightly in the pin apertures so as to allow rotation of the head relative to the handle but with some resisting friction to facilitate maintaining the head in a selected position relative to the handle.

The unique nested configuration of the mating portions of the articulating head and the handle of the preferred embodiment of the wrench of the invention allows the head to pivot relative to the handle while minimizing the distance between the pivot point and the center of component gripping aperture 14. With the wrench of the invention, when the head 12 is pivoted to a position in which the plane of the head is perpendicular to the axis of the handle, as shown in FIG. 2, the inner edge of the component engaging aperture 14 (indicated in the figure by a dashed line adjacent to the handle) is closely aligned with the adjacent face of the handle, so that the aperture can be received over a component to be engaged and turned while just barely avoiding interference with the end of the handle. Further, in the preferred embodiment shown in FIG. 2, the length of extension 16 beyond pivot pin aperture 17 is approximately equal to half the thickness of handle 11 between the two faces thereof, so that when head 12 is pivoted to a position as shown in the figure extension 16 does not protrude beyond the face of the handle or protrudes only minimally. Through a combination of these features, the space required by the wrench of the invention is reduced to a minimum, and as a result, the wrench may be used in constricted spaces that are not only inaccessible to a conventional, non-articulated wrench, but are also inaccessible to articulated wrenches known in the prior art.

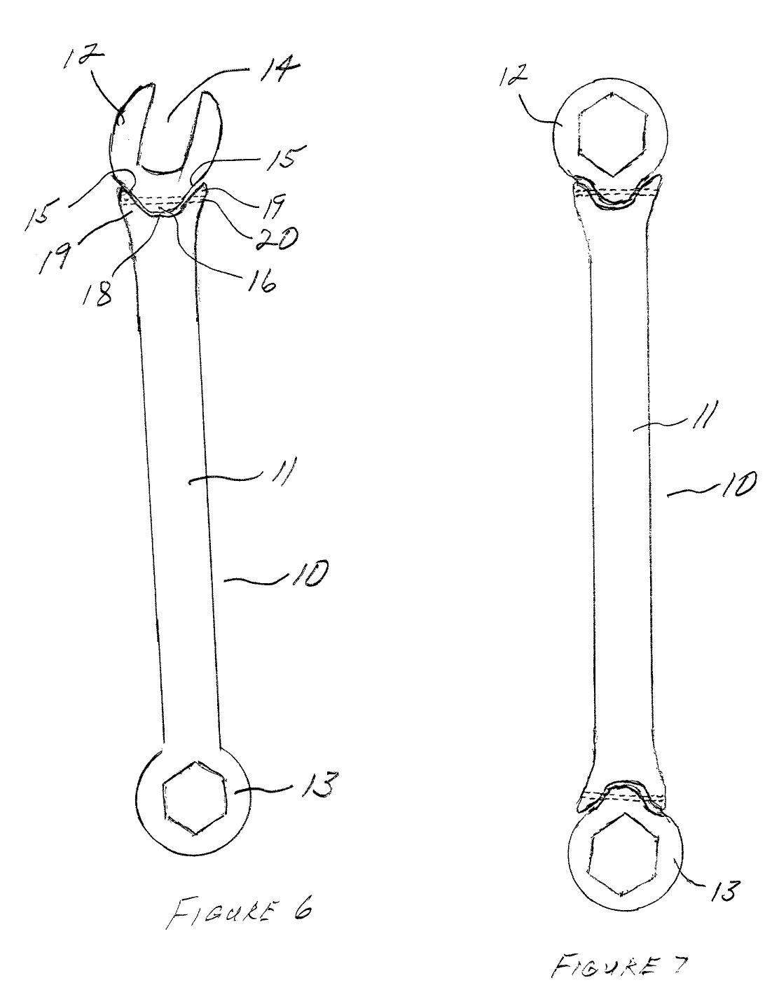

In the preferred embodiment of the wrench, the articulating head is allowed to rotate through a range of positions from parallel to the handle to perpendicular to the handle, as illustrated in FIG. 2. In many circumstances it is desirable to allow rotation through the maximum range, but in other circumstances of use it may be more desirable to restrict the degree of rotation of the head relative to the handle. An alternative embodiment of the wrench of the invention, illustrated in FIGS. 4 and 5, may be employed as a means of limiting the range of rotation of the head.

In the alternative embodiment a groove 22 is formed in extension 16 as shown in FIG. 4, centered on the diameter line across which cut-outs 15 are mirrored. A stop pin 23 is provided in depression 18 of the handle, to be received in groove 22 when head 12 is connected to handle 11. In this embodiment, the head may be rotated in either direction until the stop pin encounters the ends of the groove, thereby preventing further rotation of the head. If stop pin 23 is coaxially aligned with the longitudinal axis of the handle, the head will be allowed to pivot in either direction. If it is desired to allow the head to pivot in only one direction, stop pin 23 may be offset toward one face of the handle, as shown in FIG. 5, so that the stop pin rests against one end of groove 22 when the head is in the same plane as the handle and rotation of the head in one direction is prevented. However, rotation of the head in the other direction is allowed until the stop pin encounters the other end of the groove. It will be understood that the degree of rotation of the head relative to the handle may be controlled by varying the length of groove 22. The degree of asymmetrical rotation may also be controlled by varying the placement of stop pin 23. Accordingly, within the scope of the invention, articulating wrenches may be provided for general use and/or for specialized uses in which a particular limitation on rotation may be necessary for effective engagement and manipulation of a component to be turned with the wrench.

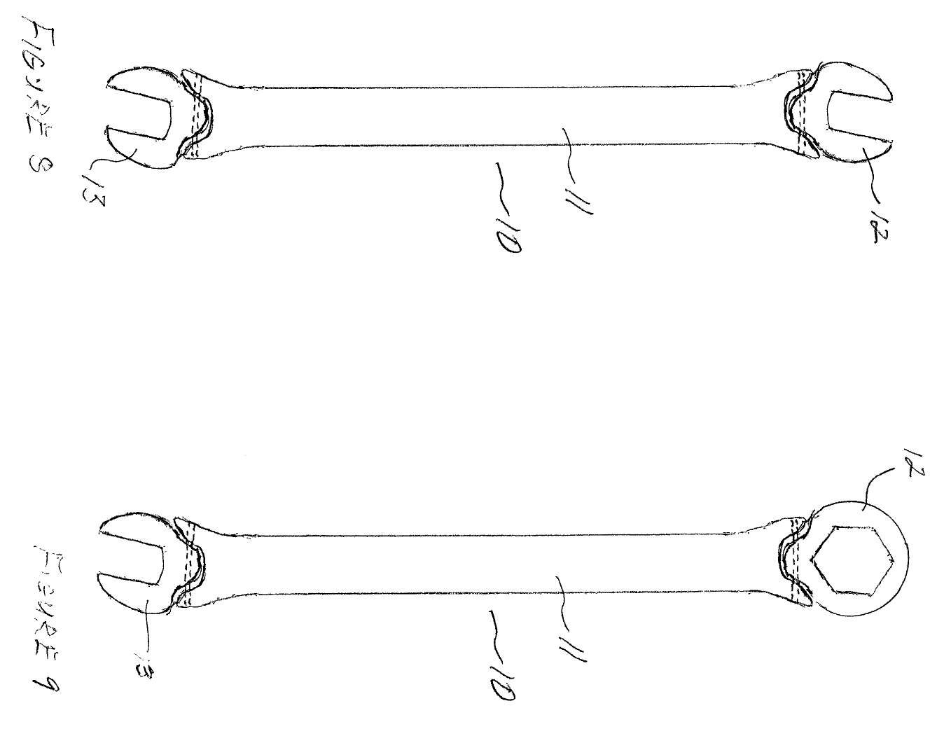

The foregoing discussion has focused on an embodiment of the wrench with one articulating box end head, but it will be understood that the principles and unique features of the invention may be utilized to provide a wrench with an articulating open end head, shown in FIG. 6. In the embodiment of FIG. 6, head 12 is the open end head and head 13 is the box end head. In the open end wrench head embodiment aperture 14 becomes a slot to receive the component to be engaged and turned, and the ring or annulus surrounding the box end head aperture referred to above is broken by the opening of the slot. The wrench of the invention may also be provided with two articulating heads, both of the same type, as illustrated in FIG. 7 (box end) and FIG. 8 (open end), or of different types, as shown in FIG. 9. The wrench of the invention may further be provided with an articulating head at only one end of the handle, with the other end of the handle left plain, without a wrench head of any type. It should also be noted that while the handle of the preferred embodiment has been described as of generally planar configuration, in order to minimize the clearance required, other handle configurations may be used within the scope of the invention. Further variations and alternative embodiments may be provided as well, all within the scope of the invention.

The foregoing description of the invention is illustrative and not limiting, and the scope of the invention as defined by the claims is intended to encompass such variations and further alternative embodiments as well as the preferred and alternative embodiments described herein.

1. An articulated wrench, comprising
an elongate handle with first and second ends, with first and second opposed edges, and with first and second opposed faces, said handle including a generally U-shaped depression extending into said handle from said first end between said edges such that an edge extension is disposed on each side of said depression; and
a wrench head formed as a generally planar body with a component engaging aperture formed in said body, having a pair of cut-outs in the edge portion of said body, said cut-outs defining an extension member therebetween, said wrench head pivotally interconnected to said handle so as to allow rotation of said wrench head in an arc generally perpendicular to the plane of said body of said head, with said extension member disposed in said U-shaped depression in said handle and with said edge extensions of said handle disposed on either side of said extension member in said cut-outs.

2. The articulated wrench of claim 1, wherein said handle includes a pair of coaxially aligned pivot pin apertures extending through said edge extensions parallel to said faces of said handle, wherein said wrench head includes a pivot pin aperture extending through said extension member in coaxial alignment with said pivot pin apertures of said handle, and wherein said wrench further comprises a pivot pin extending through said pivot pin apertures.

3. The articulated wrench of claim 1, wherein said edge extensions of said handle are flared outwardly at said first end of said handle.

4. The articulated wrench of claim 1, wherein the length of said extension member is approximately equal to the thickness of said handle between said faces.

5. The articulated wrench of claim 1, wherein said extension member has an outer end and wherein the least distance between said component engaging aperture and said outer end of said extension member is slightly greater than the thickness of said handle between said faces.

6. The articulated wrench of claim 1, wherein said extension member has an outer end and wherein the least distance between said component engaging aperture and said outer end of said extension member is approximately equal to the thickness of said handle between said faces.

7. The articulated wrench of claim 1, wherein said wrench head is a box end type and wherein said component engaging aperture is of hexagonal configuration.

8. The articulated wrench of claim 1, wherein said wrench head is an open end type and wherein said component engaging aperture is an open ended slot extending into said body of said wrench head.

9. The articulated wrench of claim 1, further comprising stop means for limiting rotation of said wrench head around said pivotal interconnection to said handle.

10. The articulated wrench of claim 9, wherein said extension member has an outer end and wherein said stop means comprises an elongate groove formed in said outer end of said extension member of said wrench head with the axis of said groove generally perpendicular to the plane of said body of said wrench head, and a stop pin extending outwardly from said depression in said first end of said handle parallel to the longitudinal axis of said handle to be received in said groove.

11. The articulated wrench of claim 10, wherein the longitudinal axis of said stop pin is aligned with the longitudinal axis of said handle.

12. The articulated wrench of claim 10, wherein the longitudinal axis of said stop pin is offset from the longitudinal axis of said handle toward said first face of said handle.

13. The articulated wrench of claim 1, wherein said handle further includes a second generally U-shaped depression extending into said handle from said second end between said edges such that an edge extension is disposed on each side of said second depression, and wherein the articulated wrench further comprises a second wrench head formed as a generally planar body with a component engaging aperture formed in said body, having a pair of cut-outs in the edge portion of said body, said cut-outs defining an extension member therebetween, said second wrench head pivotally interconnected to said second end of said handle with said extension member disposed in said second U-shaped depression in said handle and with said edge extensions of said second end of said handle disposed on either side of said extension member in said cut-outs.

14. An articulated wrench, comprising
an elongate handle with first and second ends, with first and second opposed edges, and with first and second opposed faces, said handle including an arcuate depression extending into said handle from said first end between said edges such that an edge extension is disposed on each side of said depression; and
a wrench head formed as a generally planar body with a component engaging aperture formed in said body, having an arcuate edge extending around at least a portion of said body with the curvature of a portion of said arcuate edge matching the curvature of said arcuate depression, said wrench head nested into and pivotally connected to said first end of said handle, with said arcuate depression receiving said matching portion of said edge of said body and with said edge extensions of said handle extending partially around said body of said wrench head.

15. The articulated wrench of claim 14, wherein said pivotal connection between said body of said wrench head and said handle is formed by a pivot pin extending through said edge extensions of said handle and through said body of said wrench head.

16. The articulated wrench of claim 15, wherein said pivot pin is approximately equidistant from each of said faces of said handle, and wherein the shortest distance between said component engaging aperture in said body of said wrench head and said pivot pin is approximately equal to one half the thickness of said handle between said first and second faces.

17. The articulated wrench of claim 14, further comprising stop means for limiting the rotation of said wrench head relative to said handle.

18. The articulated wrench of claim 17, wherein said stop means comprises an elongate groove formed in said portion of said body of said wrench head received in said arcuate depression in said first end of said handle, with the axis of said groove generally perpendicular to the plane of said body of said wrench head, and a stop pin extending outwardly from said depression in said first end of said handle parallel to the longitudinal axis of said handle to be received in said groove.

19. The articulated wrench of claim 14, wherein said component engaging aperture is hexagonal in configuration and is fully within said body of said wrench head.

20. The articulated wrench of claim 14, wherein said component engaging aperture is a slot extending into said body of said wrench head from the edge thereof.
